(19) United States
(12) Patent Application Publication
(10) Pub. No.: US 2019/0163277 A1
(43) Pub. Date: May 30, 2019

(54) HAPTIC OUTPUT DEVICE

(71) Applicants: Nidec Corporation, Kyoto (JP); Nidec Seimitsu Corporation, Ueda-shi (JP)

(72) Inventor: Naoki KANAI, Ueda-shi (JP)

(21) Appl. No.: 16/200,686

(22) Filed: Nov. 27, 2018

(30) Foreign Application Priority Data
Nov. 29, 2017 (JP) 2017-228686

(51) Int. Cl. G06F 3/01; G06F 3/041

(52) U.S. Cl. CPC G06F 3/016; G06F 3/0412; G06F 3/0416

(57) ABSTRACT

A haptic output device includes an actuator to generate a haptic effect, and a signal transmitter to transmit a driving signal and a braking signal to the actuator. After stopping the driving signal, the signal transmitter transmits no signal for a blank time period, and thereafter transmits the braking signal. The braking signal has a frequency equal to that of the driving signal, and a phase of the braking signal is opposite to that of the driving signal.

### CROSS REFERENCE TO RELATED APPLICATIONS

This application claims the benefit of priority to Japanese Patent Application No. 2017-228686 filed on Nov. 29, 2017. The entire contents of this application are hereby incorporated herein by reference.

### BACKGROUND OF THE INVENTION

### 1. Field of the Invention

The present invention relates to a haptic output device.

### 2. Description of the Related Art

There have been haptic output devices developed to be installed in various apparatuses, and to be capable of providing haptic feedback to users of the apparatuses. A haptic output device includes an actuator for generating a haptic effect. The actuator outputs vibrations in order to generate the haptic effect.

Once the actuator is driven, an apparatus with the haptic output device installed therein generates acceleration vibration, and thereby provides haptic feedback to the user. Once the actuator is braked, the acceleration vibration is dampened. In a case where the speed of damping the acceleration vibration is low while the actuator is being braked, the user is given an undesirable feeling. In this context, Japanese Patent Application Publication No. 2014-170534 discloses an example of a conventional haptic output device.

A haptic output device disclosed in Japanese Unexamined Patent Application Publication No. 2014-170534 includes an actuator for generating a haptic effect, and a processor. The processor transmits a driving signal and a braking signal to the actuator. Before or at the same time as the processor stops the driving signal, the processor transmits the braking signal to the actuator. The braking signal has a frequency substantially equal to a resonance frequency of the actuator, and has a phase opposite to that of the driving signal.

### SUMMARY OF THE INVENTION

Thus, there is a demand that a technology of providing an appropriate haptic effect to users be developed. The present inventors have earnestly studied and developed a novel technology for further improvement.

Exemplary embodiments of the present invention provide haptic output devices capable of enhancing an effect of damping acceleration vibration while the actuator is being braked to provide an appropriate haptic effect to the user.

A haptic output device according to an exemplary embodiment of the present invention includes an actuator to generate a haptic effect; and a signal transmitter to transmit a driving signal and a braking signal to the actuator. After stopping the driving signal, the signal transmitter transmits no signal for a blank time period, and thereafter transmits the braking signal. The braking signal has a frequency equal to that of the driving signal, and a phase of the braking signal is opposite to that of the driving signal.

Haptic output devices according to preferred embodiments of the present invention are each capable of enhancing an effect of damping acceleration vibration while the actuator is being braked to provide an appropriate haptic effect to the user.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a block diagram illustrating a configuration of a haptic output device according to an exemplary first embodiment of the present invention.

FIG. 1B is a block diagram illustrating a configuration of a haptic output device according of an exemplary second embodiment of the present invention.

FIG. 2 is an exploded perspective diagram of an exemplary actuator.

FIG. 3 is a graph illustrating examples of various waveforms which are observed while the actuator is being driven, and while the actuator is being braked.

FIG. 4 is a magnified diagram illustrating a main portion of a transition phase from a driving time period to a braking time period in FIG. 3.

FIG. 5 is a graph concerning driving and braking controls to be performed by an actuator according to a modification.

FIG. 6 is a graph illustrating an example of the braking control to be performed by the actuator.

FIG. 7 is an external appearance diagram illustrating an example of an electronic device in which the haptic output device is installed.

### DETAILED DESCRIPTION OF THE PREFERRED EMBODIMENTS

Referring to the drawings, descriptions will be hereinbelow provided for exemplary embodiments of the present invention.

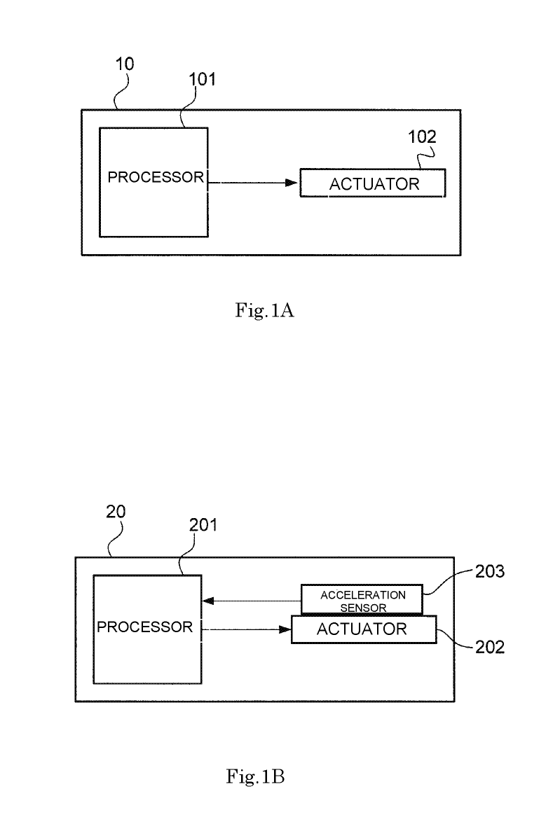

FIG. 1A is a block diagram illustrating a configuration of a haptic output device 10 according to an exemplary first embodiment of the present invention. As illustrated in FIG. 1A, the haptic output device 10 includes a processor 101 and an actuator 102.

The processor 101 is a controller for performing various processes. The processor 101 outputs a driving signal and a braking signal to the actuator 102, and thereby drives and brakes the actuator 102. In other words, the processor 101 functions as a signal transmitter for transmitting the driving signal and the braking signal to the actuator 102.

The actuator 102 has a function of generating vibrations. The actuator 102 provides haptic feedback to a user of an apparatus with the actuator 102 installed therein by generating vibrations in the apparatus. In other words, the actuator 102 generates a haptic effect. Incidentally, descriptions will be later provided for an example of a specific configuration of the actuator 102, but the configuration is not limited to the example.

FIG. 1B is a block diagram illustrating a configuration of a haptic output device 20 according to an exemplary second embodiment of the present invention. As illustrated in FIG. 1B, the haptic output device 20 includes a processor 201, an actuator 202, and an acceleration sensor 203.

The processor 201 and the actuator 202 are the same as the processor 101 and the actuator 102 according to the first embodiment which have been discussed above. The acceleration sensor 203 is a sensor for measuring the acceleration of a vibrating body (not illustrated) provided to the actuator 202. In other words, the acceleration sensor 203 detects the acceleration of the vibrations. An acceleration signal outputted from the acceleration sensor 203 is outputted to the processor 201. Based on the acceleration signal, the processor 201 performs control which will be discussed later.

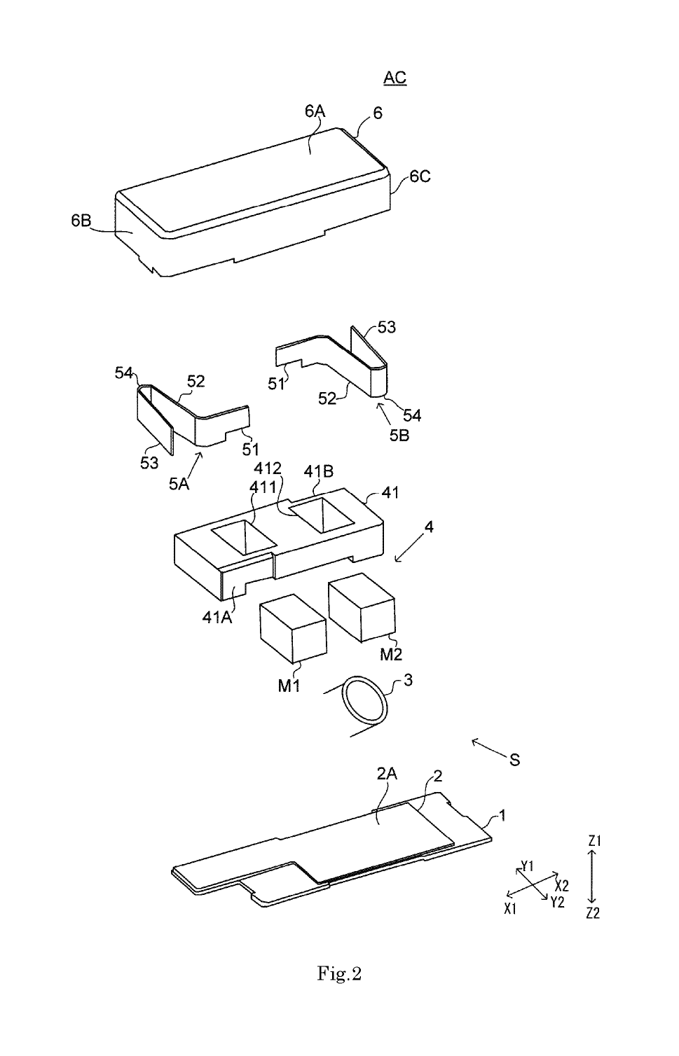

Using FIG. 2, descriptions will be provided for a configuration of the actuator employed for the haptic output devices according to the first and second embodiments.

FIG. 2 is an exploded perspective diagram of an exemplary actuator AC. The actuator AC illustrated in FIG. 2 is configured as a horizontal liner vibration motor. Incidentally, in FIG. 2, the horizontal, depth and vertical directions are referred to as X, Y and Z directions, respectively. Specifically, a horizontal-direction first side and a horizontal-direction second side are denoted by X1 and X2, respectively. A depth-direction first side and a depth-direction second side are denoted by Y1 and Y2, respectively. An upward direction and a downward direction are denoted by Z1 and Z2, respectively.

The actuator AC includes a stationary portion S, a vibrating body 4, and elastic members 5A, 5B, as its main components. The stationary portion S includes a base plate 1, a substrate 2, a coil 3, and a cover 6.

The cover 6 is a member which has a ceiling surface portion 6A in its upper portion, and whose lower portion is opened. Side surface portions 6B, 6C project downward from two edges of the ceiling surface portion 6A which face each other in the horizontal direction.

The base plate 1 is a plate-shaped member extending in the horizontal and depth directions. The substrate 2 is fixed to the upper surface of the base plate 1. The substrate 2 is formed from a flexible printed circuit board (FPC). Otherwise, the substrate 2 may be formed from a rigid circuit board. The substrate 2 extends in the horizontal and depth directions. The horizontal and depth directions are directions along a mounting surface 2A of the substrate 2. Accordingly, the vertical direction is a thickness direction of the substrate 2.

The coil 3 is mounted on the mounting surface 2A of the substrate 2. The coil 3 is formed by winding a conductive wire around its vertical axis. The coil 3 is an air-core coil with no core (a ferromagnetic core, or the like) inserted through the coil. Otherwise, the coil may be a core coil with a core inserted through the coil. The lead lines of the coil 3 are electric-conductively connected to a terminal part of the substrate 2, although not illustrated. The application of a voltage of the terminal part from the outside supplies an electric current to the coil 3.

The vibrating body 4 is arranged above the coil 3. The vibrating body 4 includes a weight 41, a first magnet M1, and a second magnet M2. The weight 41 is shaped substantially like a right-angled parallelepiped whose sides extend in the horizontal, depth and vertical directions. A first fixation surface 41A is formed in the horizontal-direction first-side portion of the depth-direction second-side lateral surface of the weight 41. A second fixation surface 41B is formed in the horizontal-direction second-side portion of the depth-direction first-side lateral surface of the weight 41. In other words, the first fixation surface 41A and the second fixation surface 41B are arranged on a diagonal of the weight 41.

Openings 411, 412 are formed in the weight 41 in a way that arranges the openings 411, 412 side by side in the horizontal direction. The openings 411, 412 extend and penetrate through the weight 41 in the vertical direction. The first magnet M1 is arranged in the opening 411, while the second magnet M2 is arranged in the opening 412.

The pair of elastic members 5A, 5B are fixed to the vibrating body 4. The elastic members 5A, 5B are plate spring members. The elastic member 5A includes a fixation portion 51, flat-plate portion 52, 53, and a connecting portion 54. The fixation portion 51 extends in the horizontal direction. A first end of the flat-plate portion 52 is joined to the horizontal-direction first-side end of the fixation portion 51. The flat-plate portion 52 extends from its first end toward the depth-direction first side. A second end of the flat-plate portion 52 is connected to a first end of the flat-plate portion 53 via the connecting portion 54. The connecting portion 54 is bent toward the depth-direction first side. The flat-plate portion 53 extends from its first end toward the depth-direction second side.

The fixation portion 51 is fixed to the first fixation surface 41A, for example, by welding. The second end portion of the flat-plate portion 53 is fixed to an inner wall surface of the side surface portion 6B of the cover 6, for example, by welding.

The elastic member 5B has a configuration similar to that of the elastic member 5A. The direction in which the elastic member 5B extends from the fixation portion 51 to the flat-plate portion 53 is reverse to the direction in which the elastic member 5A extends from the fixation portion 51 to the flat-plate portion 53. The fixation portion 51 of the elastic member 5B is fixed to the second fixation surface 41B. Accordingly, the elastic members 5A, 5B are fixed to the weight 41 at positions which are on a diagonal of the weight 41. The flat-plate portion 53 of the elastic member 5B is fixed to an inner wall surface of the side surface portion 6C of the cover 6.

Thereby, the elastic members 5A, 5B support the vibrating body 4 in a way that enables the vibrating body 4 to vibrate in the horizontal direction relative to the cover 6. In other words, the elastic members 5A, 5B support the vibrating body 4 in a way that enables the vibrating body 4 to vibrate in the linear direction. The transmission of the driving signal or the braking signal to the coil 3 from the processor (101, 201) makes the electric current flow in the coil 3. Through an interaction between the first magnet M1 and the second magnet M2, the coil 3 applies an electromagnetic force to the vibrating body 4. This makes the vibrating body 4 vibrate in the horizontal direction.

Next, descriptions will be provided for how the actuator employed for the haptic output devices 10, 20 according to the first and second embodiments works. The following descriptions will be provided on the assumption that the actuator is the above-discussed actuator AC (the linear vibration motor).

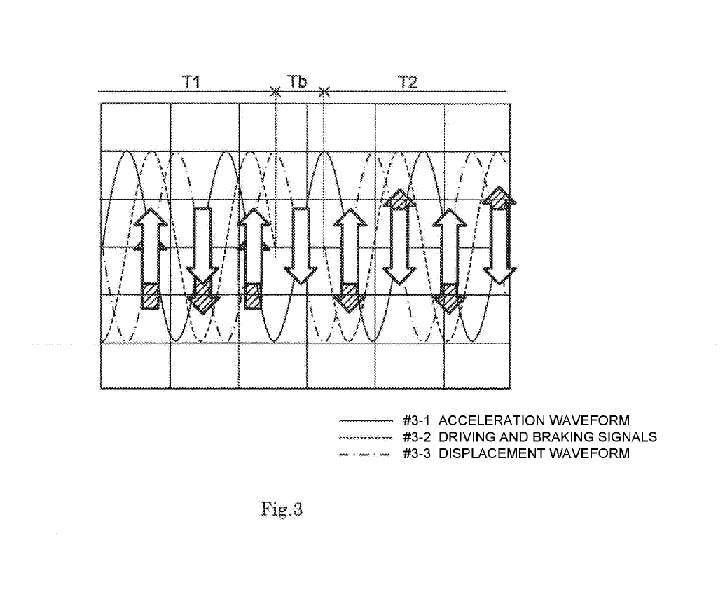

FIG. 3 is a graph illustrating examples of various waveforms which are observed while the actuator is being driven, and while the actuator is being braked. In FIG. 3, the solid line represents an acceleration waveform of the vibrating body in the actuator; the dashed line represents the driving signal or the braking signal transmitted from the processor; and the chain line represents a displacement waveform of the vibrating body.

To begin with, the processor transmits the driving signal to the actuator, and thereby drives the actuator. In FIG. 3, during in a driving time period T1, the driving signal is transmitted to the coil of the actuator. In other words, the dashed line during the driving time period T1 represents the driving signal. Thereby, the vibrating body of the actuator vibrates, and generates the acceleration waveform and the displacement waveform during the driving time period T1. The displacement waveform has a phase reverse to that of the acceleration waveform. The frequency of the driving signal is equal to the frequency of the acceleration waveform, and the phase of the driving signal advances ahead of the phase of the acceleration waveform by 90 degrees.

In FIG. 3, each arrow without hatching indicates a displacement direction of the vibrating body at timing when no displacement occurs, while each arrow with hatching indicates a direction of the electromagnetic force which the coil applies to the vibrating body at the above timing. The displacement direction is a direction in which the displacement waveform crosses 0 (zero). The direction of the electromagnetic force corresponds to the polarity of the driving signal. As illustrated in FIG. 3, during the driving time period T1, the displacement direction of the vibrating body coincides with the direction of the electromagnetic force at each timing, and the vibrating body is accelerated.

It should be noted that FIG. 3 illustrates examples of the various waveforms which are observed while the actuator is being driven in a case where the frequency of the driving signal is made equal to the resonance frequency of the actuator. Since the frequency of the driving signal is made equal to the resonance frequency of the actuator, the amplitude of the acceleration waveform becomes larger during the driving time period T1.

The processor enters into a braking time period T2 by starting to brake the actuator after a blank time period Tb following the driving time period T1. Specifically, in FIG. 3, the dashed line during the braking time period T2 represents the braking signal. The timing when the driving time period T1 ends is timing when the driving signal comes to be at 0 (zero), and is accordingly stopped. During the blank time period Tb, the processor transmits neither the driving signal nor the braking signal, that it to say, transmits no signal.

After stopping the driving signal, the processor pauses for the blank time period Tb, and thereafter transmits the braking signal to the actuator. The braking signal has the same frequency as the driving signal, and has a phase reverse to that of the driving signal. At timing when the acceleration reaches its peak after the stopping of the driving signal, the transmission of the braking signal starts with a zero level. In other words, in FIG. 3, the acceleration reaches its peak at the timing when the blank time period Tb ends, and the transmission of the braking signal starts with the zero level.

Thus, during the braking time period T2, the displacement direction of the vibrating body indicated with the arrows without hatching becomes reverse to the direction of the electromagnetic force applied by the coil which is indicated with the arrows with hatching. The vibrating body, therefore, can be decelerated. Accordingly, while the actuator is being braked, the speed of damping the acceleration vibration of the vibrating body can be increased.

Furthermore, in FIG. 3, the amplitude of the braking signal is equal to that of the driving signal. For this reason, while the actuator is being braked, the effect of damping the acceleration vibration can be enhanced.

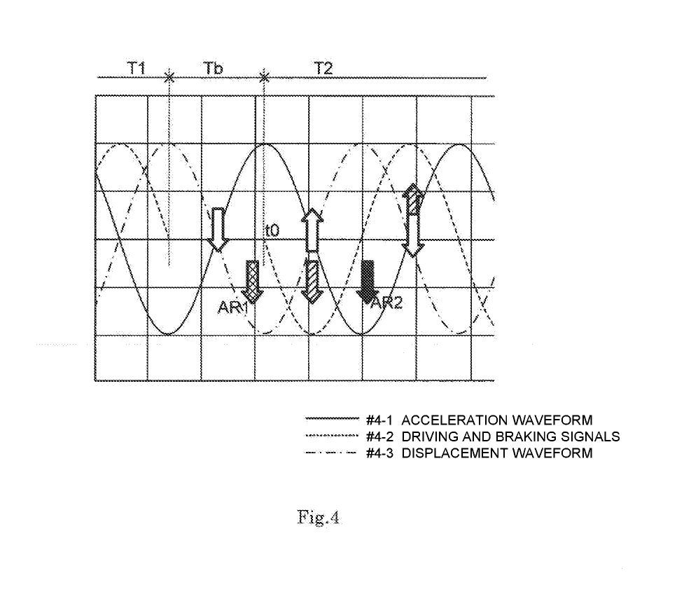

FIG. 4 is a magnified diagram illustrating a main part of the transition phase from the driving time period T1 to the braking time period T2 in FIG. 3. As illustrated in FIG. 4, at timing t0 when the acceleration waveform reaches its peak after the stopping of the driving signal, the transmission of the braking signal starts. This makes it possible to start the braking signal with the zero level. For this reason, the braking signal need not be started by being steeply raised.

In FIG. 4, an arrow AR1 indicates a direction of the electromagnetic force applied by the coil at timing when the braking signal reaches its negative peak in a case where the timing when the braking signal starts with the zero level is earlier than timing t0. In this case, at the timing indicated with the arrow AR1, the displacement direction of the vibrating body coincides with the direction of the electromagnetic force, and the vibrating body is accelerated.

Furthermore, in FIG. 4, an arrow AR2 indicates a direction of the electromagnetic force applied by the coil at timing when the braking signal reaches its negative peak in a case where the timing when the braking signal starts with the zero level is later than timing t0. In this case, at the timing indicated with the arrow AR2, the displacement of the vibrating body is static, and the vibrating body is accelerated.

In sum, in the case where the timing when the braking signal starts with the zero level does not coincide with timing t0, the effect of damping the acceleration vibration of the vibrating body while the actuator is being braked decreases. It is therefore important that the timing when the transmission of the braking signal starts be set accurately.

The method of setting the timing when the transmission of the braking signal starts is different between the haptic output device 10 according to the first embodiment and the haptic output device 20 according to the second embodiment.

In the haptic output device 10 according to the first embodiment, the processor 101 starts to transmit the braking signal at timing when the processor 101 measures a predetermined elapsed length of time from the stopping of the driving signal. The predetermined elapsed length of time corresponds to the blank time period Tb. During the blank time period, no electromagnetic force applied by the coil works on the vibrating body, and the acceleration waveform is clear. The haptic output device 10 is therefore capable of accurately identifying the timing when the acceleration waveform reaches its peak after the stopping of the driving signal, and accordingly causing the processor 101 to store an elapsed length of time until the timing as the predetermined elapsed length of time. Thereby, the haptic output device 10 is capable of accurately setting the timing when the transmission of the braking signal starts, and enhancing the effect of damping the acceleration vibration while the actuator is being braked.

In the haptic output device 20 according to the second embodiment, the processor 201 starts to transmit the braking signal at timing when, after stopping the driving signal, the processor 201 detects that the acceleration of the vibrating body reaches its peak based on the acceleration signal outputted from the acceleration sensor 203. During the blank time period after the stopping of the driving signal, no electromagnetic force works on the vibrating body, and the acceleration waveform is clear. The haptic output device 20 is therefore capable of accurately detecting the timing when the acceleration reaches its peak using the acceleration sensor 203. Thereby, the haptic output device 20 is capable of accurately setting the timing when the transmission of the braking signal starts, and enhancing the effect of damping the acceleration vibration while the actuator is being braked.

Particularly the second embodiment is capable of dealing with fluctuations in the acceleration waveform, and accordingly starting to transmit the braking signal at more appropriate timing. Incidentally, the first embodiment is advantageous over the second embodiment from a viewpoint of a simpler configuration with no acceleration sensor.

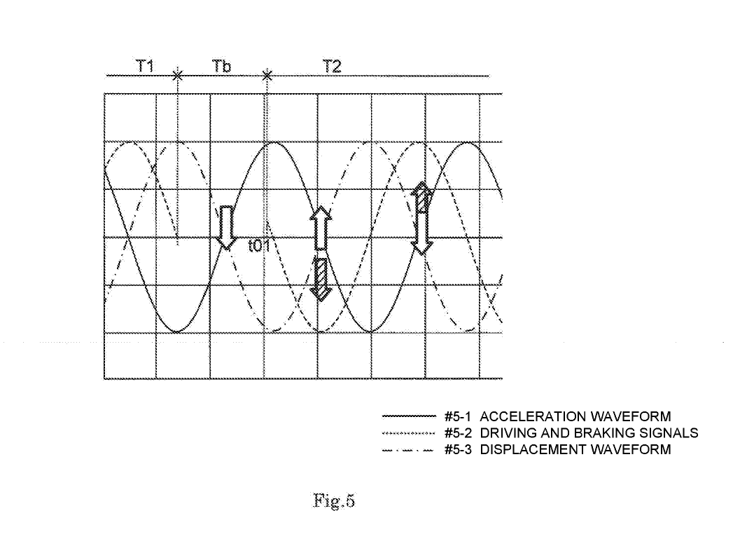

It should be noted that as a modification, the braking signal may start to be transmitted after raised from the zero level to a predetermine level at timing t01 which is slightly earlier than the timing when the acceleration reaches its peak after the stopping of the driving signal, as illustrated in FIG. 5. The phase of the braking signal at and after timing t01 is reverse to that of the driving signal. Specifically, in this case, the blank time period Tb is a time period from the timing of stopping the driving signal through timing t01. Even this configuration makes it possible to accurately set timing t01, and accordingly to enhance the effect of damping the acceleration while the actuator is being braked.

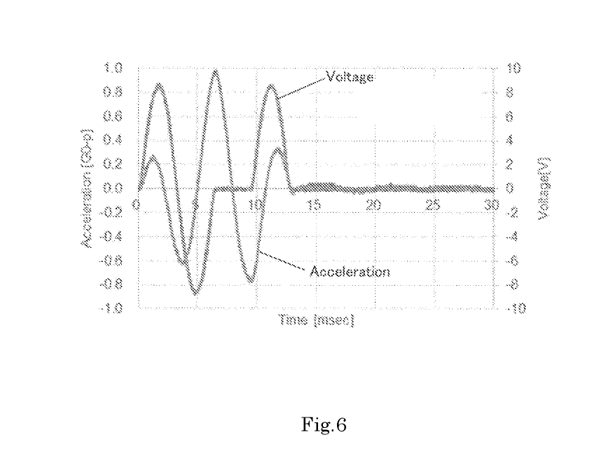

FIG. 6 is a graph concerning an example of the braking control according to the embodiments, and illustrating the effect of damping the acceleration while the actuator is being braked in the embodiments. FIG. 6 shows the acceleration waveform, as well as the driving and braking signals (in voltage).

As illustrated in FIG. 6, the transmission of the braking signal starts at the timing when the acceleration reaches its peak after the stopping of the driving signal. Thereby, the speed of damping the acceleration while the actuator is being braked is sufficiently high, as illustrated in FIG. 6.

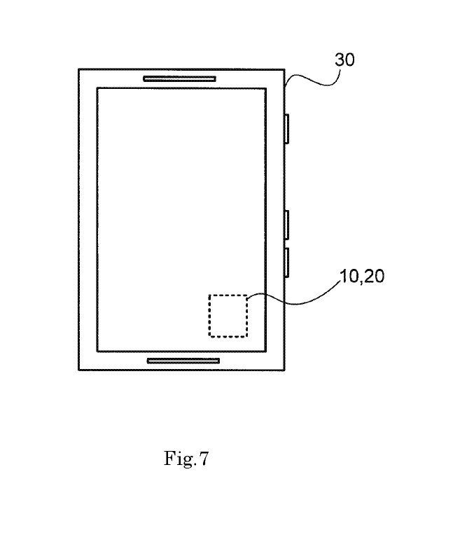

The haptic output devices according to the embodiments can be installed in various electronic devices. FIG. 7 is an external appearance diagram illustrating an example of an electronic device with one of the haptic output devices 10, 20 installed therein. The electronic device 30 illustrated in FIG. 7 includes the haptic output device 10 or 20. Vibrations are generated in the electronic device 30 by the driving and braking of the actuator in the haptic output device 10 or 20. Thereby, the user of the electronic device 30 can be given haptic feedback.

For example, when the user touches a button-shaped manipulation part of the electronic device 30 with a finger, the user can receive the haptic feedback from the manipulation part as vibrating. The user can receive a click feeling of as if the user pressed the manipulation part down. Furthermore, when the user touches a display part of the electronic device 30 with a finger, the user can receive the haptic feedback from the display part as vibrating. The user can receive a feeling of as if the user touched a physical surface, such as a feeling of smoothness and a feeling of roughness.

Specifically, a tablet computer, a smart phone and the like are conceivable as the electronic device 30. Otherwise, the haptic output device may be installed in, for example, a note-type personal computer, and the like.

Particularly, as discussed above, the haptic output devices 10, 20 according to the embodiments are capable of enhancing the effect of damping the acceleration vibration while the actuator is being braked, and accordingly inhibiting an undesirable feeling from being given to the user of the electronic device 30.

As discussed above, the haptic output device (10, 20) according to each embodiment includes: the actuator (102,202) for generating the haptic effect; and the signal transmitter (101, 201) for transmitting the driving signal and the braking signal to the actuator. After stopping the driving signal, the signal transmitter transmits no signal for the blank time period, and thereafter transmits the braking signal. The braking signal has the same frequency as the driving signal, and the phase of the braking signal is reverse to that of the driving signal.

During the blank time period, this configuration prevents an external force which would be otherwise produced by a signal from being applied to the vibrating body of the actuator, and thus makes the acceleration waveform clear. This configuration, therefore, is capable of starting to transmit the braking signal at appropriate timing, and effectively enhancing the effect of damping the acceleration vibration while the actuator is being braked. Accordingly, the user can receive an appropriate haptic effect.

Furthermore, the transmission of the braking signal starts at the timing when the acceleration reaches its peak after the stopping of the driving signal. This makes it possible to start the transmission of the braking signal with the zero level.

Moreover, the braking signal has the same amplitude as the driving signal. This makes it possible to further enhance the effect of damping the acceleration vibration while the actuator is being braked.

Besides, the driving signal has the frequency equal to the resonance frequency of the actuator. This makes it possible to increase the amplitude of the acceleration waveform while the actuator is being driven.

In addition, the signal transmitter (101) starts to transmit the braking signal at the timing when the signal transmitter measures the predetermined elapsed length of time after stopping the driving signal. This makes it possible to set the timing of starting to transmit the braking signal using the simple configuration.

The haptic output device further includes the acceleration sensor (203) for detecting the acceleration of the vibrations. The signal transmitter (201) starts to transmit the braking signal at the timing based on a signal transmitted from the acceleration sensor. This makes it possible to start to transmit the braking signal at appropriate timing depending on fluctuations in the acceleration waveform.

Furthermore, the actuator (AC) includes: the vibrating body (4); the elastic members (5A, 5B) for supporting the vibrating body in the way that enables the vibrating body to vibrate in the linear direction; and the coil (3) for applying the electromagnetic force to the vibrating body. This makes it possible to appropriately control the displacement direction of the vibrating body and the direction of the electromagnetic force applied by the coil to the vibrating body while the actuator is being braked, and accordingly to enhance the effect of damping the acceleration vibration.

Moreover, the electronic device (30) according to the embodiments includes the haptic output device (10, 20). Thereby, the electronic device is capable of inhibiting an undesirable feeling from being given to the user of the electronic device.

Although the foregoing descriptions have been provided for the embodiments of the present invention, the embodiments may be variously modified within the scope of the gist and spirit of the present invention.

The present invention is usable for haptic output devices to be installed in various apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A haptic output device comprising:
an actuator to generate a haptic effect; and
a signal transmitter to transmit a driving signal and a braking signal to the actuator; wherein
after stopping the driving signal, the signal transmitter transmits no signal for a blank time period, and thereafter transmits the braking signal; and
the braking signal has a frequency equal to that of the driving signal and a phase opposite to that of the driving signal.

2. The haptic output device according to claim 1, wherein at a timing when an acceleration reaches a peak after the stopping of the driving signal, the transmission of the braking signal starts with a zero level.

3. The haptic output device according to claim 1, wherein an amplitude of the braking signal is equal to that of the driving signal.

4. The haptic output device according to claim 1, wherein the driving signal has a frequency equal to a resonance frequency of the actuator.

5. The haptic output device according to claim 1, wherein after stopping the driving signal, the signal transmitter starts to transmit the braking signal at a timing when the signal transmitter measures a predetermined elapsed length of time.

6. The haptic output device according to claim 1, further comprising:
an acceleration sensor to detect an acceleration of vibration; wherein
at a timing based on a signal outputted from the acceleration sensor, the signal transmitter starts to transmit the braking signal.

7. The haptic output device according to claim 1, wherein the actuator includes:
a vibrating body;
an elastic support to support the vibrating body to enable the vibrating body to vibrate in a linear direction; and
a coil to apply an electromagnetic force to the vibrating body.

8. An electronic device comprising the haptic output device according to claim 1.
